(19) United States
(12) Patent Application Publication
(10) Pub. No.: US 2005/0178508 A1
(43) Pub. Date: Aug. 18, 2005

(54) Hot foil stamping or printing device for transferring surface portions onto a flat material

(76) Inventors: Armin Steuer, Waldenbuch (DE); Patrick Schoellhorn, Esslingen (DE)

Correspondence Address: NATH & ASSOCIATES PLLC, Sixth Floor, 1030 15th Street, N.W., Washington, DC, 20005-1503, US

(21) Appl. No.: 11/038,476

(22) Filed: Jan. 21, 2005

(30) Foreign Application Priority Data
Jan. 23, 2004 (DE) 102004004515.1

(51) Int. Cl. B32B 31/04; B30B 5/04

(52) U.S. Cl. 156/583.1; 156/555

(57) ABSTRACT

The hot foil stamping mechanism (11) is used for the transfer of surface portions, such as holograms, etc., onto a flat material (1) in the form of a continuous web or sheet. The hot foil stamping mechanism (11) operating in rotary manner has two cooperating cylinders forming a working gap (14) between them. For maintaining constant and precisely adjusting the working gap (14) adjusting means (40) are provided, which have an adjustable adjusting element (44a-c) engaging between the cylinders (12, 13) and acting on the latter by means of running elements (41, 50). The running elements run on the cylinder. The adjusting means can be anti-friction bearings located on the cylinder journal (28). An adjusting element in the form of a wedge or the like supports the outer ring bearings against one another and consequently maintains a constant cylinder spacing.

### FIELD OF APPLICATION AND PRIOR ART

The invention relates to an device for surface portions to a flat material by transferring, printing or hot foil stamping having an applying mechanism. Such devices are used for printing, particularly for applying coatings, e.g. metal coatings, holograms or the like present on a film web and usually having a heat seal coating or pressure-activatable coating, to a flat material, i.e. either a sheet or a continuous material web. The surface portions can be already prepared objects, e.g. holograms, or can be structured from a continuous coating by an hot foil stamping tool or die and its hot foil stamping plate, e.g. in the form of a metallized strip. Such objects are increasingly applied to security, currency and advertising materials, e.g. banknotes, entry tickets, packs, etc.

In the case of sheet-fed presses, in which in one of the cylinders is fixed a sheet partly surrounding the cylinder, on the counterpressure cylinder are provided grippers, which engage the leading edge of the sheet in order to guide it in precisely oriented manner through the sheet gap. These grippers are normally located on a pivotable gripper spindle, which is operated by a cam in such a way that they pivot between a release position engaging the sheet and subsequently releasing it again and a closed position during the actual hot foil stamping or printing process.

The operation of the gripper spindle, e.g. by a cam disk, is normally provided between the adjusting means for the working gap and the working areas. Thus, the adjusting means for the working gap are located further to the outside, so that distances between bearings are considerable and the directness of the mutual guidance of the two cylinders is reduced.

### OBJECT OF THE INVENTION

Thus, the object of the invention is to provide an applying, printing, particularly a hot foil stamping device with an improved sheet gripper mechanism, which allows a substantial clearance freedom of the printing cylinders and a direct and precise adjustability of the printing gap.

### SUMMARY OF THE INVENTION

A pivot drive for the gripper spindle is located in an area positioned outside the main bearing and also optionally the cylinder drive, namely the synchronous gears bringing about a synchronous reverse motion of the two cylinders. For this purpose a swivel shaft is positioned centrally with respect to the cylinder axis of the counterpressure cylinder provided with the grippers and in particularly preferred manner runs in a bore which from one side projects centrally into the cylinder. The driving cam can consequently be located on the outside and coupling takes place by means of cam rollers, dogs, levers or other linking members. Thus, the gripper drive is encased in the interior of the cylinder and is protected against dirtying by abraded paper waste, dust, etc.

It is important with such hot foil stamping or printing mechanisms to precisely adjust the working gap in which, during hot foil stamping, the film web with its coating is applied to the flat material, i.e. the packaging or printing material, so that an optimum hot foil stamping pressure is produced ensuring a durable, damage-free application. In all circumstances and in particular also under the influence of the heating of the hot foil stamping cylinders necessary for heat seal application, said working gap must be maintained. Account must also be taken of the influences of a mechanical nature, e.g. the bearing clearance.

The applicant has already developed a setting working with adjustable tapered roller bearings or eccentric bushes for the bearings. In other fields of application so-called bearers have been developed, i.e. ball races located on both sides of the cylinder and which have a diameter larger by the gap to be achieved than the corresponding, effective diameter of the working area of the cylinder and which ensure a constant spacing by rolling on one another. However, such bearers are difficult to adapt to the operating conditions and are consequently unsuitable for hot foil stamping mechanisms where, apart from mechanical influences, there are precise working gaps for obtaining optimum pressure ratios and an influence of heating.

In certain circumstances such bearers could be rendered adjustable by mutual bevelling, but then there would be an axial component in the hot foil stamping mechanism and the disadvantage of increased difficulty of adjustment would again arise.

Attempts have also already been made by means of support rollers to load at least one of the cylinders in the direction of the other, in order to eliminate the bearing clearance. However, this does not solve the problem of adjustability and variability of conditions.

Preferably the adjusting means have at least one adjustable member engaging between the cylinders and which acts on the latter by means of elements running thereon. Such running elements are preferably outer rings of bearings running on the cylinders, e.g. antifriction bearings. However, they do not run directly on one another and instead between them is provided an adjustable setting element, which for adjustment purposes is either displaceable roughly in the material feed-through direction and is pivotable for adjustment purposes or in some other way presses apart or spreads the two ring bearings. On either side of the cylinder such an adjusting device is provided in the vicinity of the journals, between the main bearings and the working area of the cylinder. It is also possible in place of the antifriction bearing fitted to the cylinder shaft to only provide annular, corotating raceways on which rollers run on the adjusting element and which by shifting, pivoting or the like fix the precise spacing between the two cylinder axes. In the preferred development one of the cylinders is mounted on a rocker arm, which is loaded in the direction of the other cylinder by a force component, e.g. a hydraulic cylinder. Thus, the maximum compressive force in the working gap is adjustable and in an emergency, e.g. on the entry of a much too thick material portion, can open in damage-free manner.

Thus, a precise spacing setting, optionally also with a parallelism adaptation is possible over the working gap width through a differing adjustment on the two sides of the cylinder. To the desired extent the system is extremely rigid and oscillation-free. Both cylinders with the bearing rocker arms and adjusting means are in operation mechanically a block. The main bearings of the cylinder do not have to be absolutely clearance-free. This obviates the need for excessively precise bearings and operating conditions which must be precisely maintained, which with precision bearings would e.g. also require a precisely regulated oil temperature control of the bearing lubrication. It is instead possible to operate with normal bearings and permanent grease lubrication. Moreover, in a construction with “stationary” running elements (external ring bearings) no open running surfaces exist on which particles could deposit and lead to periodic working gap changes and oscillations, as would be the case with bearers. It is also possible with the adjusting means to move as close as possible to the working area, i.e. the actual cylinder working surface and therefore also eliminate bending influences.

According to another feature of the invention the adjustability and precision of adjustment can be improved in that one of the cylinders is mounted on a rocker arm, which is mounted by a force component in the direction of the other cylinder. The rocker arm guide is particularly sensitively adjustable, but remains very stable.

The above and further features can be gathered from the claims, description and drawings and the individual features, both singly and in the form of subcombinations, can be implemented in an embodiment of the invention and in other fields and can represent advantageous, independently protectable constructions for which protection is claimed here. The subdivision of the application into individual sections, as well as the subheadings in no way restricts the general validity of the statements made thereunder.

### BRIEF DESCRIPTION OF THE DRAWINGS

The invention is described in greater detail hereinafter relative to an embodiment of an hot foil stamping device and the attached drawings, wherein show:

FIG. 1 A part sectional view of two hot foil stamping cylinders, roughly in the material running direction.

FIG. 2-4 Sections along line II-IV in FIG. 1 of three embodiments of the adjusting means according to the invention.

FIG. 5 A view along line V in FIG. 1, more particularly showing the gripper drive.

### DESCRIPTION OF A PREFERRED EMBODIMENT

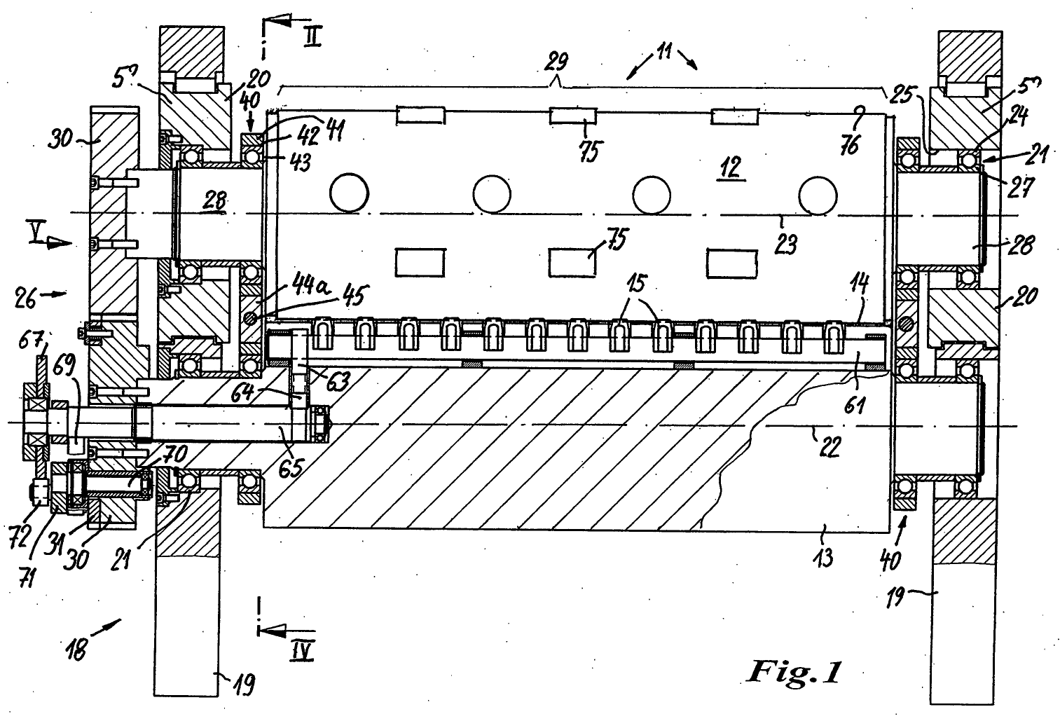

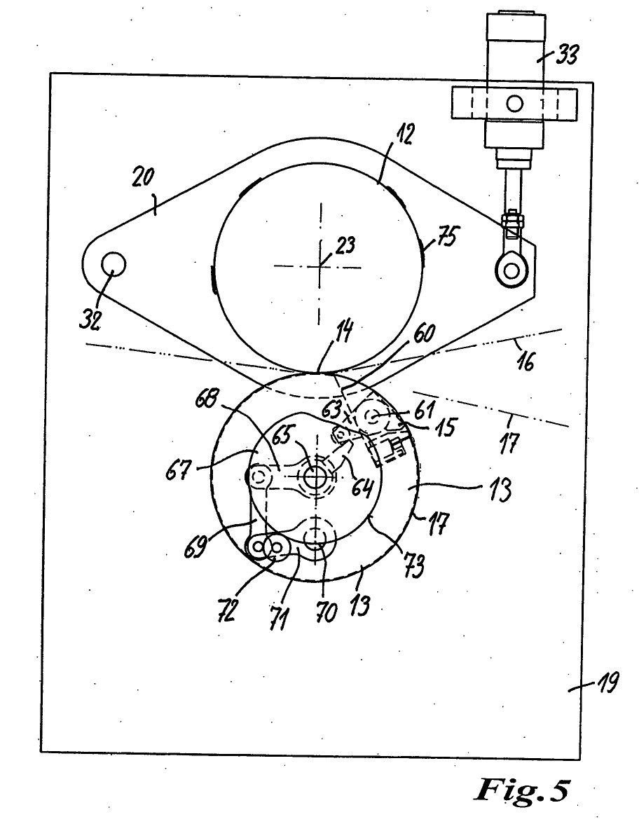

FIG. 1 shows an hot foil stamping mechanism 11 of an otherwise not shown hot foil stamping machine. It has two cylinders 12, 13, whereof the upper cylinder 12 is the hot foil stamping cylinder and they can be applied to not shown hot foil stamping dies. They serve to transfer surface portions of a film web 16 onto a flat material 17 and they are moved in superimposed manner through a working gap 14 formed between the cylinders 12, 13 (cf. FIG. 5). In the embodiment shown the flat material is formed by individual sheets of paper or similar flat materials, whose leading edge is engaged or grasped by grippers 15 and which are placed around the cylinder circumference. The flat material and film web are conveyed at the same speed as the two cylinders, drive synchronously in opposition, through the working gap 14, projections of a printing block 76 tightly spread over the cylinder 12 pressing the hot foil stamping dies 75 onto the back of the film web and emboss on the latter surface portions of a film web coating. By heating the hot foil stamping cylinder 12 a heat seal coating or some other heat or pressure-activatable adhesive coating is activated on the underside of the film web and in this way bonds the surface portions to the flat material surface. The objects or surface portions transferred from film web 16 (FIG. 5) onto the sheet 17, can either be already prepared objects, such as holograms, printed film portions or the like, or the film web can be provided with a substantially unstructured coating, e.g. of a metal foil or vapour-deposited coating from which during the hot foil stamping process specific shapes are applied to the flat material and these are determined by the shape of the hot foil stamping dies.

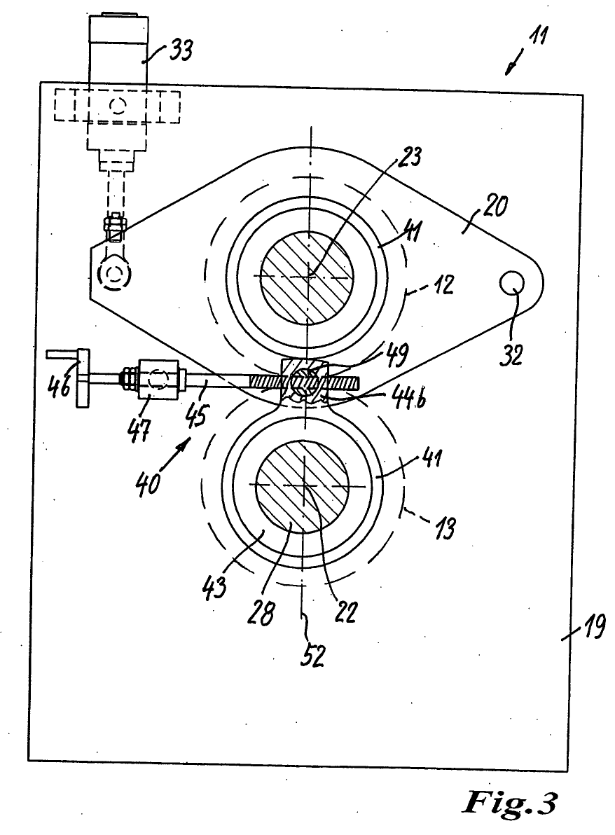

The cylinders are mounted in a frame 18, which has two machine-fixed side parts 19 (cf. also FIG. 3) and a rocker arm 20 pivotably mounted thereon and comprising two rocker arm parts 52. The lower gripper or counterpressure cylinder provided with the grippers 15 is rotatably mounted about a horizontally directed gripper cylinder axis 22 in the main bearings 21 in the side parts 19 of the frame.

The hot foil stamping cylinder 12 is also rotatably mounted about the hot foil stamping cylinder axis 23 in main bearings 21 provided in the side parts of the rocker arm 20. The main bearings 21 are antifriction bearings, whose outer races 24 are located in corresponding openings 25 of the frame side parts 19 or rocker arm 20. In each case on one side, here the left-hand drive side 26 in FIG. 1, the outer races of the ball bearings are also axially fixed in the openings. The main bearings can be antifriction bearings without excessive precision requirements, which are normally encased to the outside and provided with a permanent grease lubrication.

The inner races 27 of the main bearings are positioned radially and axially in fixed manner on journals 28, which have a smaller diameter than the cylinder diameter in the working area 29. The diameter of the cylinders 12, 13 is such that, whilst taking account of the hot foil stamping die applied and the flat material 17 to be embossed, they have the same diameter, so that their circumferential speeds during the hot foil stamping process adjacent to the working gap are precisely the same, so that no longitudinal displacements arise during hot foil stamping. This oppositely directed synchronization is brought about by a pair of synchronous gears 30, which are fitted on the drive side to the particular ends of the journals 28 and which are set in very clearance-free manner e.g. by a circumferentially adjustable gear section 31. By means of the synchronous gears driving takes place of the hot foil stamping cylinder, which is synchronized mechanically or electronically with the other functions of the hot foil stamping device, particularly flat material and film web transport.

FIGS. 3 to 5 show that the rocker arm, which can comprise two independent rocker arm parts 53 pivotable independently of one another about a frame-fixed shaft 32 are so loaded by a force component 33 that the hot foil stamping cylinder 12 mounted on the rocker arm is pressed in the direction of the counterpressure cylinder 13. For this purpose in the present embodiment the rocker arm shaft 32, the hot foil stamping cylinder axis 23 and the application point 34 of the piston rod 35 of the hydraulic cylinder 33 forming the force component are positioned substantially on a horizontal plane, which diverges slightly from the horizontal during the rocker arm movement. The force component can also be in the form of an electric linear motor, spring element, pneumatic cylinder, etc. FIG. 1 shows that the two side parts 53 of the rocker arm 20 are axially guided in corresponding recesses 36 of frame 19, but are only movable to a limited extent in the radial direction.

In order to limit in the present case the vertical movement of the hot foil stamping cylinder 12 towards the counterpressure cylinder 13, i.e. in a plane 52 including the two cylinder axes 22, 23 and therefore for adjusting the width of the working gap 14, on both sides of the cylinders 12, 13 are provided adjusting means 40.

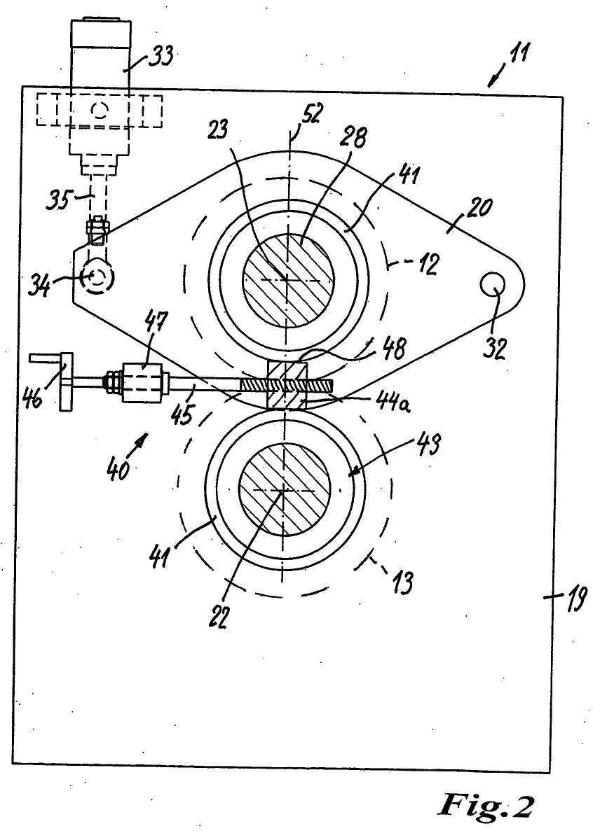

In the case shown in FIGS. 1 and 2 the adjusting means have running elements 41, which are fitted to the outer races 42 of bearings 43, preferably antifriction bearings, or are formed by said outer races. These adjusting means are fitted to the journals 28 between the working area and the main bearings 21, advantageously as close as possible to the working area of the cylinder. The running elements have a diameter which is somewhat smaller than the external diameter of cylinders 12, 13 in working area 29. Thus, the running elements run on the journals, but can be stationary relative to the frame 19 and rocker arm 20. Adjusting elements 44 engage between the running elements 41 and in the case of FIGS. 1 and 2 are in each case constructed as spherical, wedge-shaped blocks 44a. Via an adjusting spindle 45 the block 44a can be adjusted by a crank handle 46 in its horizontal position between the running elements. For this purpose the adjusting element 44a can have an internal thread cooperating with an external thread on the adjusting spindle, which is in turn axially fixed, but rotatably mounted in a bearing block 47 on frame 19.

In the case of FIG. 3 the adjusting element 44b is also displaced substantially horizontally by an adjusting spindle 45, but the bearing block 47 is pivotably fitted to the frame 19. However, the adjusting element 44b is directly fitted or integrated onto the bearing element 41 of gripper cylinder 13, so that it projects out of the running element as an upwardly directed projection and can engage with its spherical, wedge-shaped surface 48 on the running element 41 of hot foil stamping cylinder 12. In its interior is pivotably arranged a nut 49 of the thread for transmitting motions cooperating with the adjusting spindle 45, e.g. through a cylindrical outer shape of the nut 49, which is located in a corresponding recess in adjusting element 44b.

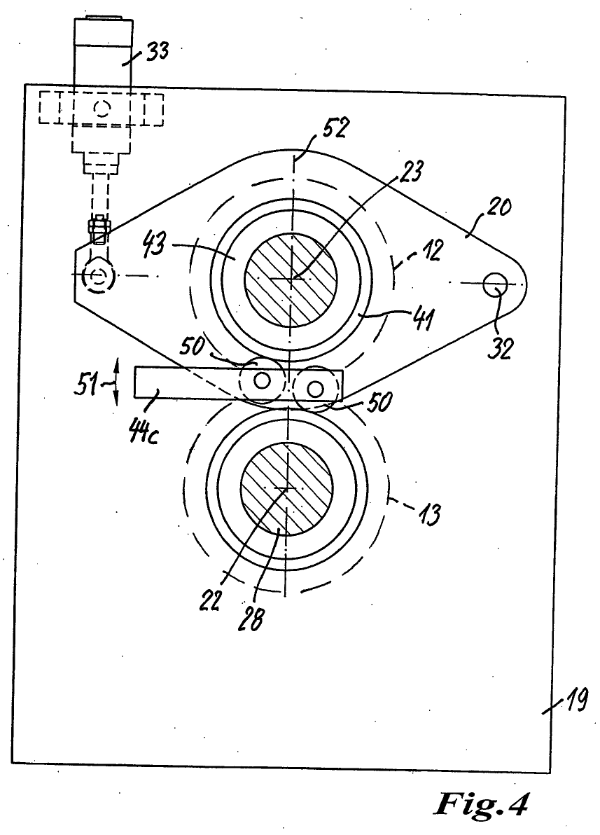

FIG. 4 shows an embodiment in which the adjusting element 44c has rollers 50, which are fitted in offset manner in such a way that in each case one of them has contact with the running element 44c of one or other cylinder 12, 13. A double arrow 51 indicates that the adjusting element 44c by pivoting the two rollers both horizontally and vertically in FIG. 4 (i.e. both in and at right angles to the plane 52 linking the cylinder axes 22, 23) are arranged in an offset manner. Thus, only one roller 50 runs on a running element 44c of each cylinder 12, 13, so that by pivoting the adjusting element 44 it is possible to adjust the spacing between the running elements and therefore between the cylinders 12, 13.

Thus, through the adjustment, e.g. by means of the crank handle 46 in FIG. 2, the block forming the adjusting element 44a can be displaced with respect to the plane 52, but not necessarily perpendicularly and through the wedge shape of the adjusting element the spacing between the two axes 22, 23 can be adjusted in an extremely precise manner, also during cylinder movement. This also applies to FIG. 3, where the shaped adjusting element 44b is pivoted about the axis 22 for adjustment purposes. As a result of the pivoting and/or a slope of the surface 48, there is a change to the “blocked” spacing of cylinders 12, 13. As a result of the pressure of the force component 33 the centre distance of the cylinders and therefore the width of the working gap between them is precisely adjusted and always maintained at a constant value. This takes place completely independently of the bearing clearance of both the main bearings and also the bearing 43 of the adjusting means, because the particular bearing clearance is eliminated by the pressure of the force component always acting in the same direction. The ball bearings 43 of the adjusting means can also be encased, permanently lubricated ball or other antifriction bearings, which are not susceptible to dirt. As the outer surfaces of the running elements 41 are stationary with respect to the adjusting element 44 in the embodiment of FIGS. 1 to 3, there is no need to fear that dirt particles will be deposited thereon which could influence the centre distance.

This is also possible in the embodiment according to FIG. 4 if the running elements 41 are provided on bearings, which render them rotatable with respect to the stub shafts 28. It is also possible under corresponding conditions to connect the running elements 44c to the cylinders to connect to rotate, e.g. also as outer surfaces on a journal collar. In this case the rollers 50 would roll on the surface of the running elements 41c, but would still ensure the adjustability and constancy of the centre distance and therefore the working gap.

Thus, the invention permits an extremely rigid, oscillation-free bearing of the cylinders, which remains constant over the entire cylinder circumference, also in the non-hot foil stamping sectors. The working gap is separately adjustable through independent adjustability of both sides of the cylinder mounted in rocker arm parts 53 and which could also be the counterpressure cylinder and this applies over the working gap width. If the latter is not desired, both rocker arm parts 53 could be interconnected to form a block by shaft 32. The parallelism of the working gap can be brought about by a synchronization of both adjusting element movements or also by a rigid rocker arm block and then the parallelism would be adjustable via eccentric bushes.

Despite the considerable rigidity of the arrangement, an overload security function is ensured and is adjustable by the force applied by the force component. If this is overcome, then the adjustably and therefore movably mounted cylinder, e.g. in the case of foreign matter penetrating the working gap can give way. It is also possible to give a very narrow axial construction to the adjusting means, so that the overall cylinder length which is critical for constructional reasons is not significantly increased.

As at least the hot foil stamping cylinder in many hot foil stamping tasks is heated to significant temperatures, the advantage also arises that if it is mounted in the rocker arm parts, the heat transfer via the journals into the frame is reduced, which not only saves energy, but also prevents undesired heat influencing of other machine parts.

FIGS. 1 and 5 show the actuation of the grippers 15. Numerous grippers 15 are fitted to a gripper spindle 61 in a recess 60 of the gripper cylinder 13. They are constructed in the manner of cams with gripper fingers and cooperate with the surface 62 of cylinder 13.

The gripper spindle extends substantially over the entire working area length and is pivotable by a lever 63, operated by means of a roller by a cam lever 64, which projects from a pivot shaft 65. The latter is pivotably mounted in a central bore 66 of the gripper cylinder 13, i.e. centrally with respect to the gripper cylinder axis 22.

The pivot shaft projects through the drive-side journal 28 and the gear 30 flanged thereto.

As can in particular be gathered from FIG. 5, the pivot shaft 65 rotating with the gripper cylinder 13 in its main movement is pivoted by means of a lever 68 projecting therefrom in superimposed manner with respect to its main movement and is connected by means of a connecting rod 69 to a lever 71 pivotable on one side about a shaft 70, on which is mounted a cam roller 72 running on cam surface 73 of cam disk 67.

FIG. 1 shows that although the cam disk 67 is located on the end of the pivot shaft, but is so mounted with respect thereto that it remains machine-fixed, whereas the drive mechanism with shaft 70, lever 71, cam roller 72, connecting rod 69 and lever 68 rotates together with the cylinder about axis 22, because the shaft 70 is mounted in the associated synchronous gear. The entire drive mechanism for the pivot drive is consequently positioned outside the cylinder drive, represented in FIG. 1 by the synchronous gears 30, so that it takes up little space between the main bearings and working area and also makes it possible to provide the adjusting means important for working gap constancy close to the working area.

The rotation sheet hot foil stamping mechanism shown in FIG. 1 with gripper cylinder 13 takes up the sheet in such a way that its leading edge can be gripped by the grippers and for this purpose they are opened in the corresponding rotation position. The grippers are opened in that by means of the cam disk 67 in the cam flattening shown at the top of FIG. 5 under the action of a not shown spring the cam roller 72 can pivot inwards, so that by means of the connecting rod 69 and the lever 68 the pivot shaft 65 rotates clockwise, so that the cam lever 64 releases the lever 63. Thus, once again using a not shown spring, the gripper spindle 61 can pivot counterclockwise and therefore open the grippers 15.

When the cam disk 67 again reaches its diameter extending over most of the circumference, the cam roller 72 is again pressed outwards and by means of the mechanism described pivots the pivot shaft 65 in each case relative to and in superimposed manner on the general rotary movement of the cylinder in a counterclockwise direction, so that the gripper spindle 61 is pivoted clockwise and closes the grippers 15.

Thus, the leading edge of the sheet is fixed and now, winding round the gripper cylinder, is drawn through the working gap 14. The latter is free as long as no hot foil stamping die projecting from the hot foil stamping cylinder 12 is in the hot foil stamping position, so that the sheet passes through. At this time the film web 16 can still have a different speed to the flat material 17 (sheet), e.g. can be stationary or even run back. Shortly before the hot foil stamping die 75, e.g. a projection on a printing block 76 fixed to the hot foil stamping cylinder 12, reaches the working gap 14, the film web 16 is brought to precisely the same speed as the flat material 17 and is subject to hot foil stamping.

It can be seen that the gripper drive is ideally integrated into the gripper cylinder and its drive and also in the case of a replacement of the gripper cylinder or dismantling for other reasons, can be removed without any significant effort.

1. Device for applying surface portions onto a sheet material (17) comprising an applying mechanism (11), which has two cooperating cylinders (12, 13) with working areas (29) rotatably mounted about parallel cylinder axes (22, 23) by cylinder bearings and rotatably driven by a cylinder drive, between which cylinders a working gap (14) being formed, the applying mechanism having adjusting means (40) for said working gap (14), one of the cylinders (13) being provided with grippers (15) for the sheet material (17), the grippers being located on a gripper shaft (61), which is pivotable between a release position and a closed position of the grippers (15), the gripper shaft (61) being actuated by means of a pivot drive (67-73), which is located on a side of one of the cylinder bearings (21) remote from the cylinders (12, 13).

2. Device according to claim 1, wherein the pivot drive (67-73), is located on a side of the cylinder drive (30) remote from the cylinders (12, 13).

3. Device according to claim 1, wherein the pivot drive has a cam disk (67).

4. Device according to claim 1, wherein the pivot drive operates the gripper shaft (61) by means of a pivot shaft (65) and connecting members (63, 64), the gripper shaft being central with respect to the cylinder axis (22) of the cylinder (13) provided with grippers (15) and/or in a recess (66) emanating from the free end of the cylinder (13).

5. Device according to claim 1, wherein the pivot drive operates the gripper shaft (61) by means of a pivot shaft (65) and connecting members (63, 64), ), the gripper shaft being in a recess (66) emanating from a free end of the cylinder (13).

6. Device according to claim 1, wherein the adjusting means (40) for said working gap having at least one adjustable adjusting element (44a-c) engaging between the cylinders (12, 13), and acting thereon by means of running elements (41, 50) running on said cylinders (12, 13).

7. Device according to claim 6, wherein the running elements (41) are provided on an outer ring bearing of said bearings (43, running on the cylinders.

8. Device according to claim 6, wherein the running elements are rollers (50) mounted on the adjusting element (44c).

9. Device according to claim 1, wherein the cylinders (12, 13) have bearing areas (28) adjacent to either side of the working areas (29) and wherein the adjusting means (40) are provided near the bearings on either side of the working area (29).

10. Device according to claim 6, wherein said at least one adjusting element (40) is displaceable substantially at right angles to the connecting plane (52) of the cylinder axes (22, 23) for adjustment purposes.

11. Device according to claim 6, wherein the at least one adjusting element (44c) is pivotable for adjustment purposes.

12. Device according to one claim 6, wherein the at least one adjusting element (44b, c) is connected to at least one of the running elements (41, 50).

13. Device according to claim 6, wherein the at least one adjusting element (44e, b) has spherical wedge surfaces.

14. Device according to one claim 6, wherein the at least one adjusting element (44c) has rollers (50).

15. Device according to claim 1, wherein it is provided to transfer the surface portions from a film web (16) to the sheet material (17) by hot foil stamping, which film web together with the film web passes through the working gap where transfer takes place.

16. Device for applying surface portions onto a sheet material (17) comprising an applying mechanism (11), which has two cooperating cylinders (12, 13) with working areas (29) rotatably mounted about parallel cylinder axes (22, 23) by cylinder bearings and rotatably driven by a cylinder drive, between which cylinders a working gap (14) being formed, the applying mechanism having adjusting means (40) for said working gap (14), one of the cooperating cylinders (12) being mounted on a rocker arm (20) which is pivotably mounted on a frame of said device and being loaded in the direction of the other one of said cooperating cylinders (13) by a force component (33).

17. Device according to claim 1, wherein it is provided to transfer the surface portions from a film web (16) to the sheet material (17) by hot foil stamping, which film web together with the film web passes through the working gap where transfer takes place.

18. Device for applying surface portions from a film web onto a sheet material (17) by hot foil stamping, comprising an applying mechanism (11), which has two cooperating cylinders (12, 13) with working areas (29) rotatably mounted about parallel cylinder axes (22, 23) by cylinder bearings and rotatably driven by a cylinder drive, between which cylinders a working gap (14) being formed, the applying mechanism having adjusting means (40) for said working gap (14), one of the cylinders (13) being provided with grippers (15) for the sheet material (17), the grippers being located on a gripper shaft (61), which is pivotable between a release position and a closed position of the grippers (15), the gripper shaft (61) being actuated by means of a pivot drive (67-73), which is located on a side of one of the cylinder bearings and of the cylinder drive (21) remote from the cylinders (12, 13), one of the cooperating cylinders (12) being mounted on a rocker arm (20) which is pivotably mounted on a frame of said device, which rocker arm being loaded in the direction of the other one of said cooperating cylinders (13) by a force component (33) including a linear drive, the adjusting means (40) for said working gap having at least one adjustable adjusting element (44a-c) engaging between the cylinders (12, 13), and acting thereon by means of running elements (41, 50) running on said cylinders (12, 13).
